(19) United States
(12) Patent Application Publication
(10) Pub. No.: US 2002/0050095 A1
(43) Pub. Date: May 2, 2002

(54) Garden hot house

(76) Inventor: Ronald W. McMullin, Raymond (CA)

Correspondence Address: DYKAS, SHAVER & NIPPER, LLP, P O BOX 877, BOISE, ID, 83701-0877, US

(21) Appl. No.: 09/928,297

(22) Filed: Aug. 9, 2001

Related U.S. Application Data
(60) Provisional application No. 60/223,917, filed on Aug. 9, 2000.

(51) Int. Cl. A01G 9/00

(52) U.S. Cl. 47/17

(57) ABSTRACT

A garden hot house for growing plants in a protected enhanced environment is made up of a translucent cover, a support frame, a mulch sheet, a temperature regulating system, at least one peg, and a quantity of dense material. The mulch sheet covers the soil surface and acts to retain heat and water within the soil. The frame is placed between mulch sheet and the cover and supports the cover, which is then placed upon the frame and secured to a base by the pegs. This defines a protective chamber. The temperature regulating system is a dark plastic tube of a desired volume filled with water placed within the chamber to moderate fluctuations in temperature. The garden hot house can be vented in a multiplicity of ways to regulate temperature while still remaining structurally stable and provides an enhanced growing environment for plants well into the plant's development.

### PRIORITY

This application incorporates by reference and claims priority from provisional application Ser. No. 60/223,917, filed on Aug. 8, 2000, entitled “GARDEN HOT HOUSE.”

### BACKGROUND OF THE INVENTION

1. Field of the Invention

The present invention generally relates to mini-greenhouses and more particularly to a protective enclosure for protecting germinating and growing plants and developing fruit, that further incorporates a heat sink for temperature regulation and stimulates rapid growth by increased temperature and moisture levels in soil and air within the enclosure.

2. Background Information

The growth of plants is strongly influenced by temperature, both of the soil and of the air. Cucumbers, for example, germinate best at a soil temperature of ninety-five degrees Fahrenheit (95° F.), a much higher temperature than is normally found in most areas of the North American continent during the spring season. Higher soil temperatures enhance germination of many food plants, yielding both shorter times for emergence and higher rates of germination. These enhanced germination qualities allow for greater success in establishing mature, productive plants.

Most plants grow better in warmer temperatures than exist in the spring season throughout most of North America. Plant phenology models, used for predicting the success of growing plants in various climates, base their analysis on a specified number of “growing degree days”. The concept upon which the model is based is that significant growth of plants will not occur until a certain minimum threshold temperature is exceeded. The rate of growth is proportional to the temperature above the minimum threshold until some maximum temperature is reached or exceeded. A “growing degree day” for a given day is equal to the average temperature for the day minus a predetermined threshold temperature. Most often the threshold temperature is fifty degrees Fahrenheit (50° F.). Once the air temperature exceeds fifty degrees Fahrenheit (50° F.), and as temperatures rise above fifty degrees Fahrenheit (50° F.), the growth of plants increases. Over a period of time a number of “growing degree days” will accumulate and the growth of the plant can be estimated by the total number of “growing degree days” that have accumulated up to that point in time. Different plants require a different number of “degree days” to reach various stages of development such as, budding, flowering, fruit presentation or fruit maturation.

When the soil and air temperatures are warmer, “degree-days” are accumulated more rapidly and plants germinate, grow, and produce fruit more quickly. However, excesses of heat will inhibit growth, prevent fruit from presenting, and may even kill the plants. Scientists have shown that fruit set (the amount of fruit produced by a plant) for tomatoes is reduced at temperatures in excess of ninety degrees Fahrenheit (90° F). Therefore, hot houses must have a means for regulation of soil temperature, air temperature, and humidity in order to maintain an optimal growing environment for the types of plants being grown therein.

Common in the prior art are greenhouses with large rigid frames covered with either glass or plastic. Ventilation systems are typically required in such greenhouses in order for the grower to maintain optimal humidity, soil and air temperatures within the structure. Greenhouses are large, relatively expensive, and usually permanent.

Plastic covered structures that use water as a heat sink and source are also common in the prior art. These structures are usually a circular, vertical set of tubes connected along their sides. When filled with water, the circle of tubes can stand vertically, forming a small enclosure within which plants are sheltered. The top of the structure can be closed by leaning the tubes inward to form a teepee shape. The major drawback to these structures is the size that the plant can attain inside the structure is usually limited to the small diameter of the circle of tubes, a diameter of about fourteen to fifteen inches (14-15″). Plants are severely restricted in their growth within these structures. In order to grow they must exceed the boundaries of the structure. If they exceed the boundaries of the structure they are exposed to the elements, including wind and cold, which can destroy them.

Additionally, these water-tube structures are not anchored and can tip over leaving the plant exposed and in some cases crushing the plant under the weight of the structure itself. This is especially true when the structures develop leaks within the tubes or are placed on uneven ground or are confronted by strong winds.

Despite these drawbacks these water-tube structures are used extensively for enhancing early growth of individual tomato plants. However, they cannot be used for protecting a multiplicity of plants at one time, nor can they be used on spreading plants such as melons, cucumbers, or squash, nor can they offer protection to an entire plant canopy at the time of initial blooming. These water tube structures must be left open at the top at the time of initial blooming because in order to develop the plants must exceed the boundaries of the structure. In leaving the tops of the structure open, the plants are susceptible to damage. By closing the tops of the structures the plants are restricted in their growth by the inner dimensions of the structure.

Another prior art method involves the use of row covers. Row covers usually require trenching for installation, are susceptible to wind damage, and require specialized irrigation such as drip irrigation systems or corrugate-type flood irrigation that generally require large quantities of water. Additionally, row covers are oftentimes very difficult to ventilate without incurring significant amounts of damage caused by the structure being ripped apart or torn from the ground by wind.

Accordingly, what is needed is a structurally stable protective enclosure, dimensioned for a variety of plants both small plants and plants with a vining habit, that can be vented to regulate temperature while still remaining structurally stable and providing an enhanced growing environment for plants well into the plant's development.

It is the object of this invention to offer a protective garden hot house dimensioned for a variety of plants, both small plants and plants with a vining habit, that can be vented to regulate temperature while still remaining structurally stable and providing an enhanced growing environment for plants well into the plant's development. It is a further object of this invention to provide a garden hot house that offers improved soil temperature and moisture retention by the use of a mulch sheet and offers enhanced frost protection and temperature maintenance by using a solar heat sink and source.

### SUMMARY OF THE INVENTION

The invention is a system for growing plants in a protected environment made up of a translucent cover, a support frame, a mulch sheet, a temperature regulating system, at least one peg, and a quantity of dense material. The translucent cover is made of an ultra-violet radiation resistant material and has a center portion and a periphery. It is dimensionally proportioned to allow the center portion to be elevated above the periphery while the periphery is secured to a solid base. The center portion of the cover has at least one vent hole, which is perforated for tearing to create an opening within the cover. The frame is made up of a circular upper ring dimensioned to have a diameter less than the diameter of the cover, and at least one leg supporting the upper ring. The mulch sheet is made of a dark plastic material dimensioned to be smaller than the periphery of the cover, and has at least one hole to allow passage of water through the mulch sheet and a planting pattern to allow the growth of plants through the sheet. The temperature regulating system is made of a dark plastic container filled with a desired volume of water. In use, the water in the container absorbs heat from direct sunlight and when the ambient temperature is greater than the temperature of the water and releases heat when the ambient temperature is less than the temperature of the water. The pegs and the dense material are placed along the periphery and hold the cover in place.

In use, the mulch sheet covers the soil surface and acts to retain heat and water within the soil. The frame is placed between the mulch sheet, and the central portion of the cover. The periphery of the cover is secured to the base by the pegs. The inner surface of the cover defines a protective chamber. The temperature regulating system is then placed within the chamber to moderate fluctuations in temperature. The result is a protective garden hot house dimensioned for a variety of plants, both small plants and plants with a vining habit, that can be vented to regulate temperature while still remaining structurally stable and providing an enhanced growing environment for plants well into the plant's development.

Still other objects and advantages of the present invention will become readily apparent to those skilled in this art from the following detailed description wherein I have shown and described only the preferred embodiment of the invention, simply by way of illustration of the best mode contemplated for carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 is a sectional representational perspective of the first embodiment of the garden hot house.

FIG. 2 is a sectional representational perspective of the embodiment in FIG. 1 located over a micro-basin formed in a soil base

FIG. 3 is a top planar view of the embodiment in FIG. 1.

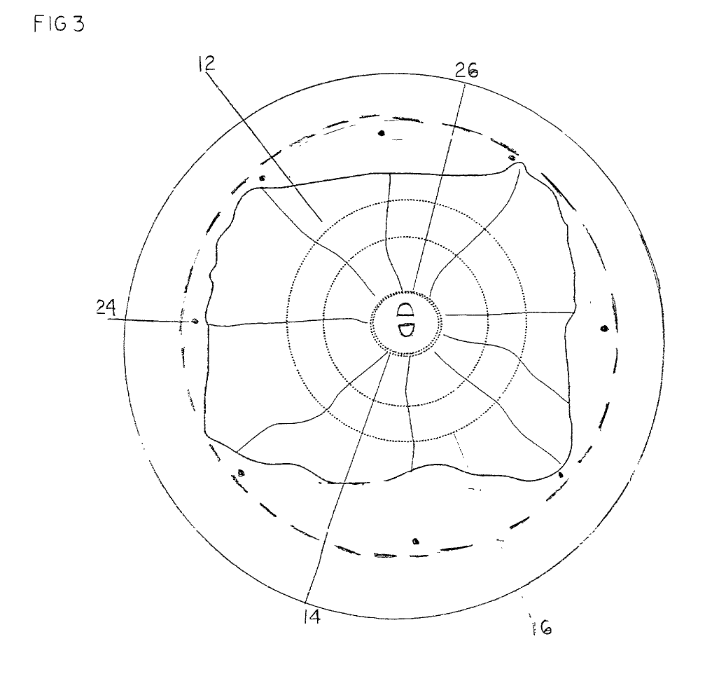

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

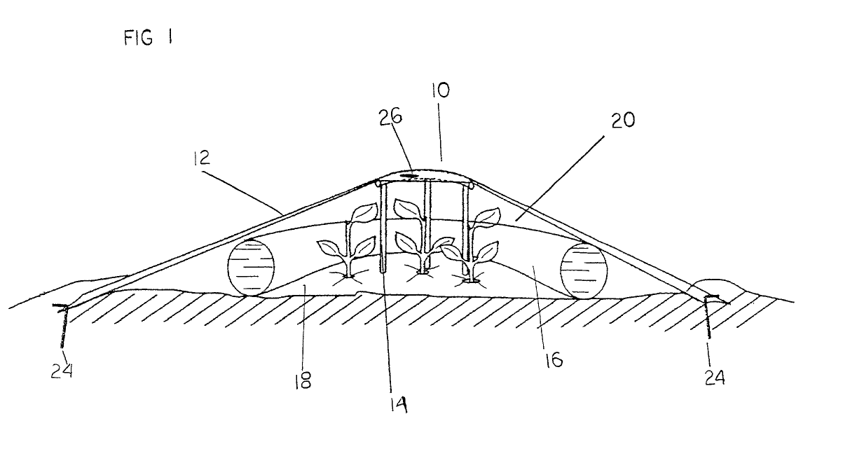

Referring to FIG. 1, a first embodiment of a garden hot house 10 is shown. A cover 12 is draped over a frame 14 defining a protective, growth-enhancing chamber 20. A mulch sheet 18 covers a soil surface and provides a floor for the chamber. A heat sink 16 lies within the chamber atop the mulch sheet. The cover 12 is made of a suitable material that is resistant to UV light degradation and allows for the penetration of sufficient light for optimal plant growth. The cover may be clear or translucent as long as sufficient light for optimum growth penetrates to the plants below.

Cover 12 protects the plants from wind, and retains heat and moisture including the moisture that has been evapo-transpired by the plants. This evapo-transpired moisture may condense on the cover and coalesce, then run down the sides of the cover to be reincorporated into the ground and recycled.

To allow for ventilation within the chamber, cover 12 has perforated vent holes 26 at the top of the structure to allow venting of excess heat from the structure. The positioning of the vent holes at the top of the cover allows hot air to be released more efficiently because hot air rises. Additionally, by positioning the vents at the top of the structure, the vents are strengthened by the frame, and damage to the cover by wind or weakening of the structure is prevented. The user can at their discretion open up as many vent holes as are deemed necessary to adjust existing or anticipated temperature within the enclosure.

Cover 12 is dimensioned to allow the central portion of the cover to be raised above the plants and cover the mulch sheet and the plants beneath until the user deems it better that the plants be exposed to the outdoors, at which time the cover can be easily removed. The cover is also appropriately dimensioned to allow a portion of the periphery to be raised while the cover is suspended over the frame and another portion of the cover 12 is anchored to a base. This provides a secondary mode for regulating the temperature within the chamber.

Frame 14 supports cover 12 and provides structure for the cover vent holes 26. The upper ring of the frame 14 has a smaller diameter than the protective enclosure formed by cover 12 when it is draped over frame 14. In practice, it is found that if the diameter of the frame 14 is dimensioned to be approximately one quarter of the diameter of the protective enclosure at its widest portion, when fully formed by cover 12, then the erected structure has an aerodynamic shape with little resistance to the wind. This aerodynamic shape has enabled garden hot houses of the design of the first embodiment to protect plants in areas with winds in excess of fifty miles per hour (50 m.p.h.). Given the dome-shape of the protective enclosure formed by cover 12, the garden hot house is symmetrical in all directions and thus the direction of wind is of no consequence. A portion of the legs of the frame inserted into the earth supports the frame.

Additionally, the garden hot house has some snow-bearing capacity. Protective enclosures such as those shown in FIG. 1 have remained intact, during testing throughout a winter in southern Alberta, Canada at the site where the present invention was tested.

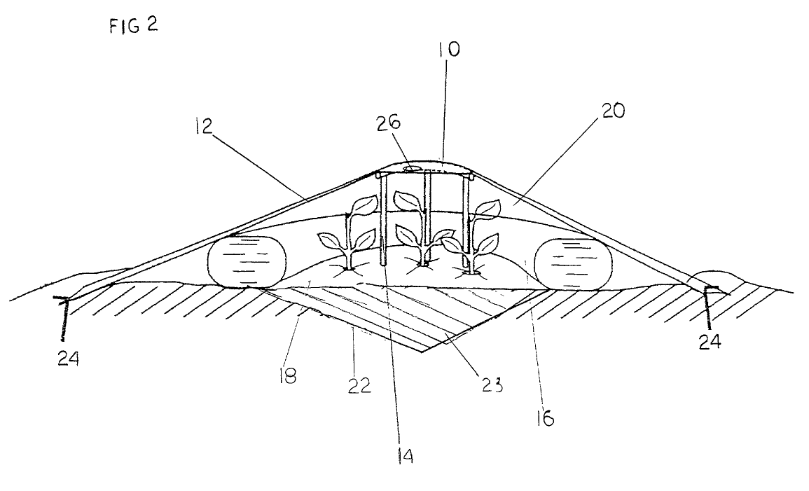

In FIG. 2. the best mode for use in a soil base is demonstrated. Prior to erection of the garden hot house, a saucer-shaped micro-basin 22 is formed in the soil that will lie directly below the mulch sheet. The micro-basin 22 is formed by the user, utilizing a garden rake and/or shovel to create a saucer-shaped basin wherein the central portion of the basin is lower than the peripheral edge. In this embodiment, the micro-basin 22 is about six (6) feet in diameter with a depth in the center of about two (2) to three (3) inches. The basin gently slopes from the center upward to the ground surface at its outer edge. The soil within the micro-basin 22 is topsoil 23, optionally mixed with organic material and a balance of fertilizers. The fertilizers are composed of both fast and slow release nitrogen for sustained growth and other plant nutrients, such as phosphorus, potassium, sulfur, and other elements as deemed necessary to promote plant growth, in sufficient and balanced proportions for plant nutrition of the desired plant species. A urease inhibitor may be added to the fertilizer to inhibit the rapid release of nitrogen into the soil, and allow the nitrogen to be released over a period of time rather than instantly as many fertilizers do.

The micro-basin 22 allows for efficient water use. It's bowl-like shape in the soil holds water better than a flat surface. Water can be applied to the plants in the micro-basin 22 at a much faster rate than would otherwise be possible because the basin holds the water in place even if the water application rate exceeds the rate of water absorption by the soil. This prevents runoff and concentrates the applied water to the plants within the micro-basin 22. The planting pattern for the plants takes advantage of this property and arranges the plants in such a way that the plants in the micro-basin benefit most from water applications, yet have adequate distance between themselves and other plants so that plant growth is not inhibited.

Experiments show that earthworm numbers increase under the mulch in the microbasin 22 and that the earthworms make many channels in the soil. As a result, the water infiltration rate of the soil under the mulch and in the micro-basin 22 may increase dramatically over time as the structure remains in place.

A mulch sheet 18 covers the soil surface and is placed on top of the topsoil 23 within the micro-basin 22. In this embodiment the mulch sheet 18 is a black plastic cover that traps heat and moisture within the soil and allows for transmission of heat to the soil below. Soils covered with a mulch sheet 18 retain heat longer than soils left bare. This facilitates germination of some plant species such as melons and cucumbers, which require relatively high soil temperatures for rapid and successful germination. Certain food plants are heat loving plants and grow much faster when soil temperatures are relatively high and more slowly when soil temperatures are colder.

Mulch sheets also retain moisture in the micro-basin and the area below it by providing a layer that is relatively impermeable to moisture. Holes and/or slits in the plastic allow water and air to pass through the mulch sheet 18 into the ground below, and allow for plants to grow through the mulch sheet 18. These holes and/or slits are designed such that a minimum amount of bare soil is exposed to evaporative forces.

The mulch sheet 18 provides a planting pattern of holes either pre-formed or pre-perforated to allow a pattern to be adapted to both seeding and transplanting plants into the soil below. In the preferred embodiment, the planting pattern is laid out and precut in the plastic mulch sheet 18. The user has a diversified selection of patterns based upon the types and quantity of plants desired to be grown. The mulch sheet is adaptable to the growth of many different types of plants, although it is particularly designed for the growth of cucumbers, melons, peppers, and/or tomatoes.

Another advantage of mulch sheet 18 is that it prevents weed growth. Mulch sheet 18 can be designed to remove sufficient light or filter light waves to prevent weed growth below the mulch.

As shown in FIG. 1, heat sink 16 is provided as part of the garden hot house. In this preferred embodiment, it is a dark colored plastic tube filled with water that functions as a solar heat sink and a source of latent heat. The tube of water moderates temperatures inside the garden hot house, particularly when plants are small and outdoor temperatures are cool. Water is known to have a high heat capacity, of one calorie per gram per degree Celsius, and is readily available at minimal cost. When the internal air temperature of the hot house is greater than the temperature of the water within the tube, the water absorbs the heat. Additionally, by having the tube be a dark color the tube absorbs light and heat energy directly, which is then stored in the water. When the ambient temperature within the enclosure is lower than the temperature of the water, the heat retained by the water in the tube and heat sink 16 is released to the surrounding air inside the protective enclosure. This slows the decline of temperatures inside the garden hot house as outdoor temperature declines. This feature is particularly important early in the growing season when outdoor temperatures are lower than those required by plants for growth. The heat sink 16 can also prevent frost damage in cold conditions by releasing heat as the water starts to freeze. The latent heat of solidization for water is quite high at approximately 80 calories per gram. The release of this latent heat as water freezes is a valuable source of heat during hard frost conditions.

The structure of the heat sink 16 also acts as a berm to form a small reservoir around the planting holes in mulch sheet 18. When water is applied to the central part of mulch sheet 18, the tube of water of heat sink 16 helps keep the irrigation water in the central part of the micro-basin 22. This is important when the garden hot house is installed on sloping ground that would otherwise cause water to run to one side of the micro-basin, leaving some of the plants on the uphill side of the basin drier than others. Other materials may also be used as a heat sink; these include mixtures of water and non-toxic anti-freeze, sand and water, soil and water, mixtures of sand and soil, or even collections of bricks and/or fieldstones.

The peripheral edge of a plastic cover 12 is secured to the ground by the use of a plurality of pegs. In the preferred embodiment, the cover 12, is placed over frame 14 and pegs 24 are inserted through precut holes to peg cover 12 to the ground.

Soil, which is readily available, may be used as a structural component of the garden hot house 10. The user places a shovel full of soil over that portion of the cover between each pair of adjoining pegs. The soil anchors the cover in place and makes it impervious to wind by covering the edge of the cover 12. The soil can be easily removed so that the protective cover 12 can be opened, and the soil can be easily replaced to close the cover 12 again. Other dense materials may be used in place of soil such as other forms of particulate matter, a tube of water, a brick or even fieldstones, but soil is readily available in the garden and in most cases has a relatively high density.

The garden hot house 10 is simple to install and requires only common garden tools, namely a rake and a shovel for installation. One person can accomplish all of the installation, including planting, in 15 to 20 minutes.

The garden hot house 10 allows the user great flexibility in temperature management. By opening and closing various parts of the garden hot house the user is able to vary temperatures so as to optimize growing conditions for plants. Temperatures can reach forty degrees Fahrenheit (40° F.) higher in a closed protective enclosure garden hot house 10 than outside on a bright, sunny day, for example. The user may take full advantage of that heat early in the growing season to increase plant growth. The inventor's research has shown growth of melons, tomatoes and peppers to optimized by temperatures of 105 degrees to 115 degrees Fahrenheit (105° F.-1150° F.) in the pre-flowering stage. To use the full heat offered by the sun for enhanced plant growth, the protective enclosure is kept closed. As outdoor temperatures increase, an additional forty degrees Fahrenheit (40° F.) may be detrimental to plant growth. In order to maintain optimum plant growing conditions, the user can lower the temperature within the enclosure.

There are at least three ways to lower temperatures within the protective enclosure. The first is to open one or two of the perforated vent holes 26 found in the central portion of cover 12 immediately over and surrounded by the frame 14. This is preferably done on a semi-permanent basis, where the vent hole will remain open for the rest of the season. Temperatures decline ten to fifteen degrees Fahrenheit (10° F.-15° F.) when both vent holes are open. When the threat of frost has passed, and the person does not wish to attend to the garden hot house 10 on a regular basis, both vent holes can be opened and temperatures rarely rise above 110 degrees Fahrenheit (110° F.) within the enclosure.

Another way to regulate the temperature within the enclosure is to remove one or more of the pegs 24 on the peripheral edge of cover 12 and roll the resulting loose plastic upward toward the frame. The rolled plastic is secured with a clamping device such as a clothespin or a paper clamp (not shown). In the early spring when frosts are still a threat, this is the preferred method as the plastic can be rolled down before nightfall and temperatures are kept at a higher level inside the hot house. The protective cover 12 can be opened and closed many times this way. Temperatures decline ten to fifteen degrees Fahrenheit (10° F.-15° F.) when one peg is removed and that portion of the bottom is opened. The structure remains strong enough to resist winds with the plastic rolled up because the rest of the structure remains taught. Two or three adjacent pegs 24 can be removed to enlarge the opening as needed, or alternate pegs can be removed and the cover 22 rolled up to provide for one to four openings in the bottom of the protective enclosure.

Another way to regulate temperature is to remove the cover 12 entirely. By removing the pegs the protective cover 12 can be removed entirely. This is the normal practice when flowering is extensive and pollination is ongoing. Removal of the cover provides adequate access to flowers by bees and other pollinators and maintains temperatures more optimal for pollination and fruit set.

By maintaining temperatures near optimum levels for growth during much more of the growing season, yields from the plants are increased. Scientists have shown that plasticulture covers and mulches increase fruit yield by 25% to 100% in most cases. Not only does fruit mature earlier when a garden hot house 10 is used, but the length of the production season can be extended. Plants grown in a garden hot house will usually bear fruit three weeks to one month earlier than plants grown without a protective enclosure. Additionally, those plants grown in a garden hot house will produce fruit for an additional period of time to the benefit of the user.

The garden hot house 10 can also be used for double cropping in a single season. The cover and frame can be used to start somewhat frost tolerant plants, such as cabbages, radishes, beets, peas, onions, etc. Once these plants are well established and the frost-free period approaches, the cover can be removed and used with the entire garden hot house system to grow heat-loving plants. This extends the growing season for as much as six (6) weeks for a user of the garden hot house.

Many heat-loving plants that grow best in plasticulture structures are of tropical origin and benefit from increased humidity. The garden hot house 10 offers a closed system during the pre-flowering stage of plants and thus provides for higher humidity within the enclosure than without. Condensation on the inside of the cover is typical in a closed garden hot house 10, indicating high moisture content in the air.

Watering a garden hot house is simple and efficient. A garden hose is placed in the central part of the structure, either under the edge of the cover or from above through a vent hole and water from the hose runs onto and through the mulch sheet. The mulch sheet 18 prevents erosion of soil despite the velocity of water from the hose. The holes and slits in the mulch sheet 18 allow for water penetration through the mulch sheet and into the soil. The micro-basin formed by the user retains the water in close proximity to the planting pattern. All of the water applied will be available for use by the plants planted by the user, there is no runoff, and weeds are not watered. In terms of water use efficiency, the irrigation efficiency of this method may approach 100%, and if water is applied without excess to cause deep percolation, water use efficiency may actually be 100 percent (100%).

In order for plants originally grown in hot and humid environments to survive when subjected to cooler, drier and windier environments, they must be “hardened off” or the plant may be damaged or killed when put in the harsher environment. An immediate removal of the plastic cover without first hardening plants off can cause damage. In other plasticulture methods, the plant must grow either out of the shelter of the structure or through holes or larger holes must be cut in the plastic over time to gradually expose the plant to the elements.

In the garden hot house 10, the bottom of the peripheral edge of cover 12 can be opened over time to allow for gradual acclimatization of the plants without destroying portions of the structure. This allows plants to be hardened off gradually and maintain the leaves in prime condition to continue the manufacture of photosynthates required for plant growth and fruiting.

This also means that the user can utilize the cover for a number of years, and only the one or two vent holes in the top which are opened by the user must be taped closed for use in the following season.

To harden off plants, the user pulls a peg 24 and secures the loose plastic. This forms an open triangle and results in a temperature drop of about ten degrees Fahrenheit (10° F.). In one or two days another peg, being at least one peg away from the first peg previously pulled, can be pulled and the plastic rolled up and secured. Now there are two triangular openings and the temperature drops another five to ten degrees Fahrenheit (5° F.-10° F.). This continues until every other peg is removed, creating four triangular holes, and achieving near-outdoor temperatures inside the structure. The majority of cover 12 is still in place protecting the plant from wind, while the plant acclimatizes. If temperatures are high, the entire cover 12 may then be removed.

When temperatures decline later in the growing season, the user may choose to replace cover 12 to increase heat in the central portion of the plant. In the case of lower growing plants such as vining crops and small bush-type tomatoes this will stimulate growth and protect the plant and fruit within the confines of the structure from frost while they mature.

One unique advantage of the garden hot house 10 is that the frame 14 and cover 12 can be transformed into a support mechanism to prevent wind damage. Tomatoes are planted in two adjoining planting holes on one side of the mulch sheet 18 and another set of two adjoining planting holes on the opposite side of mulch sheet 18. This leaves a strip of the mulch sheet 18 in the center without plants. The two pairs of plants are separated in the center by the frame. When the tomatoes are in bloom, the cover 12 over the two sets of tomato plants can be removed, one peg at a time, to allow for hardening. The two pegs closest to each pair of tomatoes are then pulled. Four pegs are eventually left in the ground, the pairs of two pegs adjoining the plantless strip in the center of the garden hot house. The cover 12 is then tucked behind the tomato plants and pressed against the legs of the frame. This provides a plastic strip about the width of frame 14, running from side to side, behind and separating the two pairs of tomato plants. Experience has shown that this support is sufficiently flexible as to cushion the plants as they are blown in the wind and prevents them from moving excessively and thus keeps the tomato plants from being damaged by the wind. Furthermore, by leaving the cover in place over the center of the mulch sheet, higher soil temperatures are maintained than if the whole cover had been removed, and the growth rate of the tomatoes is improved.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A protective enclosure for facilitating the improved growing of temperature sensitive plants in a solid earth base in cold climates comprising:
a cover, for protecting plants, formed of a material which allows passage of a quantity of light sufficient to support the growth of plants, and reduction of heat loss and evaporation of water away from plants, having an inner surface, an outer surface, and a center portion extending outward to a periphery;
a support, for elevating said center portion of said cover in relation to the periphery of said cover, the inner surface of said chamber defining a protective chamber with said solid earth base; and
a heat sink for absorbing radiant heat from sunlight and releasing latent heat into said protective chamber.

2. The protective enclosure of claim 1 which further comprises an anchoring device, for securing the periphery of said cover to said solid earth base.

3. The protective enclosure of claim 2 wherein said anchoring device is at least one peg driven through the periphery of said cover into a quantity of earth.

4. The protective enclosure of claim 1 further comprising a dense material placed along the periphery of said cover for sealing said cover to a solid base.

5. The protective enclosure of claim 1 wherein said cover center portion is further configured for the selective creation of at least one vent hole.

6. The protective enclosure of claim 1 further comprising a mulch sheet for positioning on the solid earth base under the protective chamber and having at least one means for allowing passage of water through said mulch sheet into the earth.

7. The protective enclosure of claim 6 wherein said mulch sheet is formed of a material which functions as a means for retaining heat and water within the earth.

8. The protective enclosure of claim 8 wherein said mulch sheet is formed of a material which functions as a heat sink for absorbing radiant heat from sun light and releasing latent heat into the earth and the protective chamber.

9. The protective enclosure of claim 7 where said mulch sheet further has a planting pattern, said planting pattern having at least one opening at a desired location within said mulch sheet adequate to contain a growing plant.

10. The protective enclosure for growing plants of claim 1 wherein said heat sink is at least one dark colored plastic container filled with a quantity of a heat sink material.

11. The protective enclosure for growing plants of claim 11 wherein said heat sink material is water.

12. The protective enclosure of claim 1 wherein the support for elevating the center portion of the cover is a frame positionable beneath said cover.

13. The protective enclosure of claim 13 wherein said frame comprises a circular upper ring and at least one leg supporting said upper ring, said upper ring dimensioned to have a diameter less than the diameter of said cover, whereby said frame elevates the central portion of said cover above the periphery of said cover.

14. The protective enclosure of claim 1 wherein said cover is made of a material which is resistant to degradation by ultra-violet light.

15. A device for growing plants in the ground within a protected environment comprising:
a cover having a center portion, and a periphery, said center portion further having at least one vent hole cover, said vent hole cover configured for tearing creating an opening within said cover, said cover dimensionally proportioned to allow said center portion to be elevated above said periphery forming a protective chamber, said cover further being formed of a material which allows passage of a quantity of light sufficient to support the growth of plants;
a frame, for elevating the central portion of said cover above the periphery of said cover to form an enclosure;
an anchoring means for securing the periphery of said cover to the ground;
a mulch sheet positionable upon the ground under the cover, for retaining heat and moisture within the ground, said mulch sheet proportionately dimensioned to be smaller than the periphery of said cover, said mulch sheet further having at least one means for allowing passage of water through said mulch sheet, and a planting pattern comprising at least one opening of a desired size, placed in a desired location sufficient to allow the growth of a plant; and
a temperature regulating system for tempering fluctuations in temperature within said chamber, said temperature regulating system comprising a heat sink material for absorbing radiant energy from sunlight and releasing latent heat when the temperature of the heat sink material exceeds the temperature within the enclosure, said temperature regulating system placed within said enclosure upon said mulch sheet.

16. The device for growing plants in a protected environment of claim 15 wherein said temperature regulating system comprises a dark colored plastic tube filled with water.

17. A system for growing plants in a protected environment comprising:
a translucent cover made of an ultra-violet radiation resistant material having a center portion, and a periphery, said center portion further comprising at least one vent hole, said vent hole perforated for tearing and creating an opening within said cover, said translucent cover dimensionally proportioned to allow said center portion to be elevated above said periphery while said periphery is secured to a solid base;
a frame comprising a circular upper ring and at least one leg supporting said upper ring, said upper ring dimensioned to have a diameter less than the diameter of said cover, whereby said frame elevates the central portion of said cover above the periphery of said cover;
a mulch sheet made of a dark plastic material, and placed on a soil surface, said mulch sheet proportionately dimensioned to be smaller than the periphery of said cover, said mulch sheet having at least one opening sufficient to allow passage of water into said soil surface, and further comprising a planting pattern comprised of at least one opening in said mulch sheet in at least one desired location; and
a temperature regulating system comprising at least one dark plastic tube of a desired volume filled with an equal volume of water wherein said water absorbs heat when the ambient temperature is greater than the temperature of said water and releases heat when the ambient temperature is less than the temperature of said water;
at least one peg to secure said cover to a solid base; and
a quantity of a dense material placed along the periphery of said cover;
whereby said mulch sheet covers said soil surface and acts to retain heat and water within said soil, said frame is placed upon said mulch sheet, said cover central portion is placed upon said frame and said periphery is secured to said solid base by said peg, said cover forming a protective chamber, said temperature regulating system is then placed within said chamber to moderate fluctuations in temperature.

18. A method of creating an environment suitable for growing temperature sensitive plants in cold climates comprising
digging a micro-basin in a quantity of soil, said micro-basin having a soil surface, a circumvolving rim, a depressed central portion; and a solid base, wherein said depressed central portion is lower than said circumvolving rim to allow water to be retained after watering, said micro-basin further comprising a quantity of soil appropriately prepared for the growing of plants;
placing a mulch sheet proportionately dimensioned to said micro-basin on top of the prepared soil, said mulch sheet further having at least one opening for allowing the passage of water into said soil and at least one planting pattern having at least one opening suitably sized and located for the growing of a plant;
installing a temperature regulating means wherein said temperature regulating means comprises a dark colored container of a desired volume filled with a desired amount of a heat sink/source material;
covering said micro-basin with a cover formed of a material which allows passage of a quantity of light sufficient to support the growth of plants, said cover having a central portion, and a periphery, said central portion further having at least one vent hole located within said center portion;
elevating the central portion of said cover by use of a support means such that an enclosure is created is created beneath the cover; and
anchoring said cover periphery to the soil.
